(19) United States
(12) Patent Application Publication
(10) Pub. No.: US 2006/0167727 A1
(43) Pub. Date: Jul. 27, 2006

(54) Method for the controlling of a logistics chain

(76) Inventor: Werner Thoren, Steinen (DE)

Correspondence Address: BACON & THOMAS, PLLC, 625 SLATERS LANE, FOURTH FLOOR, ALEXANDRIA, VA, 22314, US

(21) Appl. No.: 10/843,304

(22) Filed: May 12, 2004

(30) Foreign Application Priority Data
May 13, 2003 (DE) 10 321 619.7

(51) Int. Cl. G06F 9/44

(52) U.S. Cl. 705/7

(57) ABSTRACT

According to the method, the current measurements from sensors S1, S2 are transmitted into a Supply Chain Management-application. In this way, the current measurements are always available to the Supply Chain Management-application.

The invention concerns a method for controlling a logistics chain, according to the preamble of claim 1.

The logistics chain plays a crucial role in industrial production. Only in the case of a perfect functioning of the logistics chain is an optimal production process possible.

Under the catchword “Supply Chain Management,” various methods and procedures are available for the management of a logistics chain. Generally, under “Supply Chain Management”, one understands the management of the flow of goods within a supplier- and purchaser-network, such that the correct goods are available at the correct time in the correct amount and quality at the correct place. An important goal of Supply Chain Management is the reduction of production costs. An essential factor in production costs is storage costs, which can amount to a third of all logistics costs.

Given that, as a rule, various enterprises are involved on a logistics chain, enterprise-spanning applications for the controlling of logistics chains are known (e.g. mySAP, of the firm SAP AG).

An essential disadvantage of presently known methods and procedures for controlling logistics chains is that, within the logistics chain, the inventories are monitored only at limit values, and business processes (e.g. production requirements, ordering, allocation of transport capacities) are only initiated when certain limit values of the inventories are reached. This is also referred to as “Event Management.”

With this way of controlling, the phenomenon referred to as the “Bullwhip Effect” can occur, i.e. a small change of an inventory at the beginning of a logistics chain can bring about considerable changes in subsequent sections of the chain. Such effects can initiate unnecessary ordering/production reactions and thereby lead to increased stock, which unnecessarily increases the total costs of production.

In many cases, business processes are initiated on the basis of inventory data from bookkeeping. This inventory data can deviate from the actual inventory in stock.

An object of the present invention is to provide a method for the controlling of a logistics chain, which method does not exhibit the aforementioned disadvantages, and which method is, in particular, simply and cost-effectively realizable.

This object is achieved by means of the criteria stated in claim 1.

An essential idea of the invention is to register, continuously with sensors, the inventories of a logistics chain, and to forward the measured values of these sensors to a central control unit, and evaluate them there. In this way, current measurements are available for business processes (production requirements, ordering, allocation of transport capacities, order fulfillment between the enterprises).

In a further development of the invention, business processes are initiated on the basis of the dynamic behavior of one or more measured values of the inventory. Thus, not only the instantaneous, actual values (e.g. limit values) are applied to the control of the logistics chain, but also dynamic changes of the measured inventory.

In a further development of the invention, for example, the rate of change of the measured values of individual inventories is taken into account.

Advantageously, the method of the invention can be applied in the case of tank- or silo-containers, the fill levels of which are being continuously measured.

As sensors, fill-level measuring devices, especially those using microwaves, are suited for this purpose.

Given that the measurements must be obtained from several enterprises, it is preferred to equip the sensors with an Internet connection.

Advantageously, the measurements are evaluated in a Supply Chain Management-application, which runs in the control unit. A Supply Chain Management-application can be, for example, an SAP-application from the firm SAP® AG.

The invention will now be explained in greater detail on the basis of an example of the embodiment illustrated in the figures, as follows.

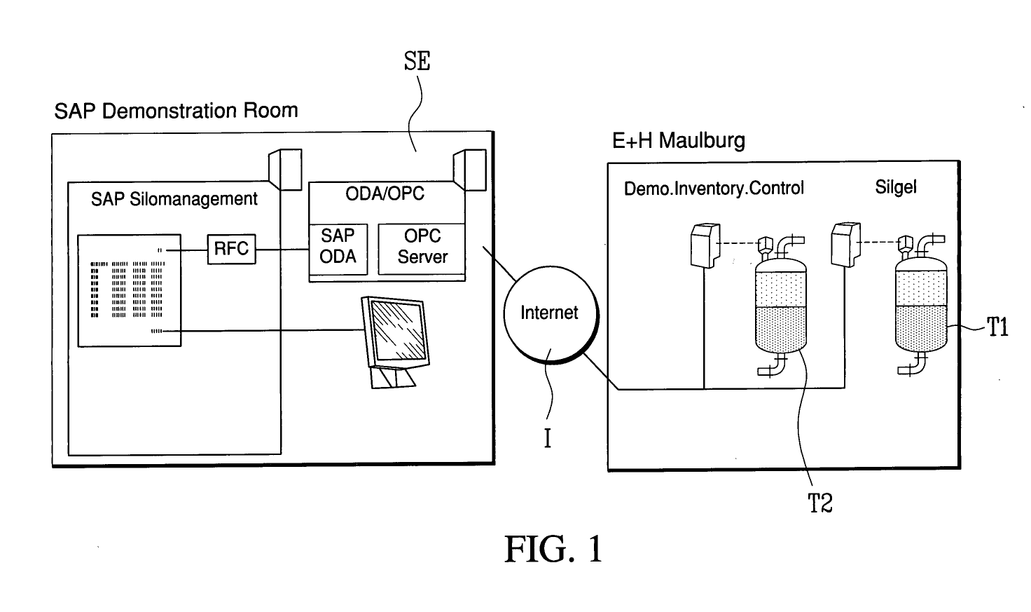

In FIG. 1, two tank-containers T1, T2 are represented as storage containers of a highly simplified logistics chain. Each of these two tank-containers has a sensor S1, S2 for determining the fill level of the substance in the inventory container. The substance can be a bulk material or a liquid. The substance can serve within the logistics chain as raw material, intermediate product, or end product. The two sensors S1 and S2 are connected by means of a connection unit (e.g. Fieldgate®, from the firm Endress+Hauser®) with an enterprise-spanning communication network I (e.g. Internet). A control unit SE, which has an OBC-server, is connected with the Internet I. By means of the OBC-server, the measurements, which reflect the current inventory in the tank-containers, are retrieved from the sensors S1, S2. By means of an interface SAP/ODA, the measurements are transferred into a SAP Supply Chain Management-application (Silo Management), which serves for the controlling of the logistics chain. That is, from this application, production requirements, orders for the substances in the tanks T1, T2, or for additional ingredients needed for the production of these substances, are initiated.

Likewise, transport capacities are allocated from this application, in order to transport the substance from tank T1 to tank T2. The controlling of business processes by means of an SAP-application is common knowledge, and will not be further explained here. It is understood that the control unit, for this purpose, must be networked with various enterprise branches.

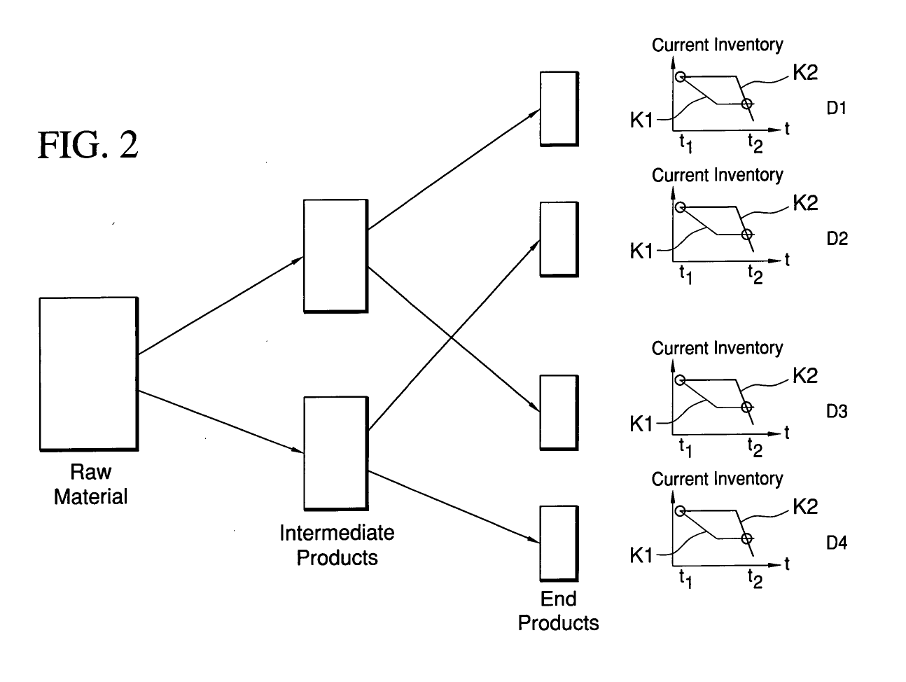

In FIG. 2, a logistics chain with one raw material, as well as multiple intermediate- and end-products, which are stored in suitable storage containers, is schematically represented. In the case of the end products, the current measured inventories are represented in diagrams D1, D2, D3, D4 as a function of time t.

In each diagram, two different curves are plotted. At the point in time t₁, the inventory of the corresponding end-product changes only slightly; whereas at the point in time t₂ it changes greatly. If only the actual value of the inventory is evaluated, then the same business processes are initiated at both points t1, t2, although the need for raw materials or intermediate products differs considerably. In the case of the sharply decreasing curve K2 at point t2, production requirements must be urgently initiated by the raw material supplier or by the producer of the intermediate products. If need be, also transport capacities must be made available. In the case of curve K1, which at point t2 essentially is not changing, no urgent business processes must be initiated. As is clearly seen here, the dynamic behavior of a measured inventory is essential for the appropriate decision concerning the business process to be initiated.

The method of the invention will now be described in greater detail as follows. The controlling of the logistics chain is accomplished in a way such that the inventory, i.e. the fill levels in both of the tank-containers T1, T2 is registered continuously with the sensors S1, S2, and the measurements of these sensors S1, S2 are transmitted to a control unit SE, and are evaluated there. In the control unit SE, business processes are initiated not only on the basis of actual values, e.g. that certain limit values in the tank-containers T1, T2 are subceeded, or fallen below; rather, the dynamic behavior of the measurements is evaluated, as well. If a measurement (inventory) is very quickly decreasing at a specific point in time, when a limit value is reached, then corresponding preliminary products must be produced in greater amounts, and/or corresponding transport capacities must be made available. In this way, the logistics chain can be controlled such that the costs of production, or storage, as the case may be, are considerably reduced. In this way, because the dynamic behavior of the inventories is taken into account, the corresponding control loops for controlling the inventories and the flow of material within the logistics chain, can be optimized. Given that the book inventories often deviate from the actual inventories, the method of the invention means that business processes can be reliably initiated on the basis of current measurements.

In the case of the method of the invention, the current measurements of the sensors S1, S2 are transmitted into a Supply Chain Management-application. A Supply Chain Management-application can be, for example, a SAP-application mySAP of SAP AG.

1-7. (canceled)

8. A method for controlling a logistics chain having multiple inventories comprising the steps of:
the inventories are continuously registered with sensors;
transmitting the measurements of the sensors to a central control unit; and
evaluating the measurements in the control unit.

9. The method as claimed in claim 8, further comprising the step of:
initiating business processes on the basis of the dynamic behavior of the measurements.

10. The method as claimed in claim 9, wherein:
the dynamic behavior of a measurement is its rate of change.

11. The method as claimed in claim 8, wherein:
the measurements are fill levels in storage tanks or silos.

12. The method as claimed in claim 8, wherein:
the sensors are fill-level sensors.

13. The method as claimed in claim 8, wherein:
a Supply Chain Management-application is implemented in the control unit.

14. The method as claimed in claim 8, wherein:
the Supply Chain Management-application is a SAP-application.
